(19) United States
(12) Patent Application Publication
(10) Pub. No.: US 2025/0306545 A1
(43) Pub. Date: Oct. 2, 2025

(54) SUPPORT SYSTEM, SUPPORT METHOD, AND NON-TRANSITORY COMPUTER READABLE MEDIUM

(71) Applicant: Yokogawa Electric Corporation, Tokyo (JP)

(72) Inventors: Mika KAWATA, Tokyo (JP); Hiroaki SOYA, Tokyo (JP); Yasuhiro MATSUI, Tokyo (JP); Toshio YOSHIDA, Tokyo (JP)

(21) Appl. No.: 19/083,327

(22) Filed: Mar. 18, 2025

(30) Foreign Application Priority Data
Mar. 26, 2024 (JP) 2024-049586

(51) Int. Cl. G05B 13/04; C02F 1/00

(52) U.S. Cl. CPC G05B 13/041; C02F 1/008; C02F 2209/001; C02F 2209/006

(57) ABSTRACT

A support system is provided which includes an acquisition unit which acquires a measured value in a sewage treatment system; a computation unit which uses a model for controlling the sewage treatment system which is generated based on the measured value and a manipulated variable given to the sewage treatment system to calculate a manipulated variable to be given to the sewage treatment system depending on the measured value newly acquired; and a simulation unit which calculates a state of the sewage treatment system depending on the manipulated variable calculated in the computation unit by simulation.

The contents of the following patent application(s) are incorporated herein by reference: NO. 2024-049586 filed in JP on Mar. 26, 2024

### BACKGROUND

### 1. Technical Field

The present invention relates to a support system, a support method, and a non-transitory computer readable medium.

### 2. Related Art

Patent Document 1 or the like describes “in a sewage treatment process, . . . it is suggested to control the process by using a model to improve efficiency” in paragraph 0002 of Patent Document 1.

### PRIOR ART DOCUMENTS

### Patent Documents

Patent Document 1: Japanese Patent Application Publication No. 2021-26617
Patent Document 2: Japanese Patent Application Publication No. 2017-91056

### BRIEF DESCRIPTION OF THE DRAWINGS

FIG. 1 illustrates a sewage treatment system 1 according to an embodiment.

FIG. 2 illustrates a support system 2 according to an embodiment together with the sewage treatment system 1.

FIG. 3 illustrates an operation of the support system 2.

FIG. 4 illustrates an example of a computer 1200 in which a plurality of aspects of the present invention may be wholly or partially embodied.

### DESCRIPTION OF EXEMPLARY EMBODIMENTS

Though the present invention will be hereinafter described through embodiments of the present invention, the following embodiments are not intended to limit the invention according to the claims. In addition, not all combinations of features described in the embodiments are essential to a solution of the invention.

### Sewage Treatment System

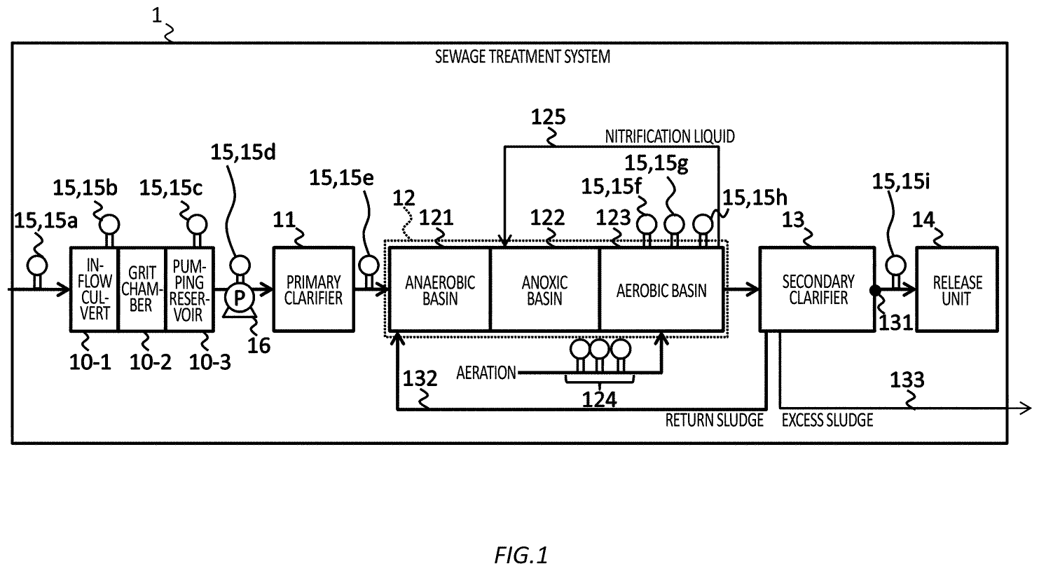

FIG. 1 illustrates a sewage treatment system 1 according to the present embodiment. The sewage treatment system 1 includes an inflow culvert 10-1, a grit chamber 10-2, a pumping reservoir 10-3, a primary clarifier 11, a reaction vessel 12, a secondary clarifier 13, and a release unit 14 in an order from an upstream side to a downstream side. Though in the present embodiment, as an example, the sewage treatment system 1 is described as performing sewage treatment by an anaerobic-anoxic-oxic method, it may perform the sewage treatment with another approach.

The inflow culvert 10-1 is a structure such as a water channel and a ditch for taking in sewage. In general, the sewage taken into the inflow culvert 10-1 flows into the primary clarifier 11 via the grit chamber 10-2 and the pumping reservoir 10-3. The grit chamber 10-2 is a chamber for settling grit, dirt, or the like included in the sewage to remove it, and the pumping reservoir 10-3 is a water vessel used for pumping up the sewage into the primary clarifier 11. A pump 16 is provided between the pumping reservoir 10-3 and the primary clarifier 11.

In the primary clarifier 11, solid matter included in the sewage flowed from the pumping reservoir 10-3 is removed by settlement. The solid matter removed in the primary clarifier 11 may be sand or floating substances which may have not been removed in the grit chamber 10-2. Supernatant water in the primary clarifier 11, namely the sewage after the solid matter is removed flows into the reaction vessel 12.

The reaction vessel 12 is a tank for treating the sewage and includes an anaerobic basin 121, an anoxic basin 122, and an aerobic basin 123 in the order from the upstream side to the downstream side. In the anaerobic basin 121, microorganisms take in acetic acid and butyric acid in the sewage and discharge phosphoric acid. The sewage treated in the anaerobic basin 121 flows into the anoxic basin 122. In the anoxic basin 122, nitric acid and oxygen included in a nitrification liquid are changed to nitrogen by microbial respiration and released into an atmosphere, a process of which is referred to as denitrification. The sewage treated in the anoxic basin 122 flows into the aerobic basin 123. In the aerobic basin 123, the sewage flowed from the anoxic basin 122 is aerated. In this way, in the aerobic basin 123, oxygen and ammonia nitrogen in the sewage are oxidized by an action of nitrite bacteria and nitrification bacteria to change into nitrate nitrogen, a process of which is referred to as nitrification. One or more blowers 124 for aeration are connected to the aerobic basin 123, and the aeration in the aerobic basin 123 is controlled depending on a number of blowers 124 to be operated and an airflow rate. In addition, the microorganisms take phosphorus in the aerobic basin 123. A tube 125 in communication with the anoxic basin 122 is provided in the downstream side of the aerobic basin 123. In this way, return water which includes nitrate nitrogen, or the nitrification liquid, is supplied from the aerobic basin 123 to the anoxic basin 122. The sewage treated in the aerobic basin 123 flows into the secondary clarifier 13.

In the secondary clarifier 13, activated sludge including microorganisms which took phosphorus is removed from the sewage flowed from the aerobic basin 123 by settlement, the process of which is referred to as dephosphorization. Supernatant water in the secondary clarifier 13 is released as treated water from a release port 131 to the release unit 14. In the secondary clarifier 13, a tube 132 in communication with the anaerobic basin 121 is provided. In this way, a part of the settled activated sludge is returned as return sludge from the secondary clarifier 13 to the anaerobic basin 121. The remaining activated sludge in the secondary clarifier 13 is discharged to the release unit 14 as excess sludge. The excess sludge may be discharged via a tube 133 which is provided separately from the release port 131.

The sewage treatment system 1 includes a plurality of sensors 15 which measure process data, also referred to as a measured value. Each sensor 15 may perform a measurement periodically, such as at 1-to-15-minute intervals as an example. The process data may include, for example, an inflow quantity, a water level at the inflow culvert, a water level at the pumping reservoir, a pumping quantity, a turbidity, which is also referred to as influent water quality, dissolved oxygen, or DO, a concentration of ammonia nitrogen, or NH₄—N, mixed liquor suspended solids, or MLSS, effluent water quality, or the like.

The inflow quantity is a quantity of the sewage flowing into the sewage treatment system 1 per unit time. In the present embodiment, as an example, the inflow quantity is a water quantity flowing into the inflow culvert 10-1 and may be measured by the sensor 15 which is installed in an inflow port to the inflow culvert 10-1, which is also referred to as sensor 15a.

The water level at the inflow culvert represents a level of water being stored in the inflow culvert 10-1. The water level at the inflow culvert may be measured by the sensor 15 which is installed in the inflow culvert 10-1, which is also referred to as a sensor 15b.

The water level at the pumping reservoir represents a level of water being stored in the pumping reservoir 10-3. The water level at the pumping reservoir may be measured by the sensor 15 which is installed in the pumping reservoir 10-3, which is also referred to as a sensor 15c.

The pumping quantity is a water quantity released from the pumping reservoir 10-3 to the primary clarifier 11 and represents a quantity of the sewage treated in the sewage treatment system 1. The pumping quantity is measured by the sensor 15 which is installed in an inflow port to the primary clarifier 11, which is also referred to as a sensor 15d.

The turbidity represents a degree of cloudiness of the sewage. The turbidity, for example, is measured by the sensor 15 which is installed before the anaerobic basin 121, which is also referred to as a sensor 15e.

DO represents a concentration of the oxygen dissolved in the sewage. DO in the aerobic basin 123 corresponds to a difference between air or an oxygen quantity supplied by the aeration and an oxygen quantity consumed by the microorganisms in the treated water. In the sewage treatment system 1 according to the present embodiment, DO varies depending on the airflow rate in the aerobic basin 123 so that it may be controllable by the airflow rate and may be used as one of manipulated variables. NH₄—N represents the concentration of the ammonia nitrogen included in the sewage. NH₄—N increases with degradation of nitrogen compounds included in the sewage and the increased NH₄—N decreases with an action of the microorganisms in the sewage which take the oxygen supplied through the aeration. MLSS is a concentration of organic matter in the aerobic basin 123 and represents a concentration of the microorganisms. DO, NH₄—N, and MLSS are respectively measured by the sensor 15 which is installed in the aerobic basin 123 and also referred to as the sensor 15f, 15g, and 15h. NH₄—N and MLSS may be a management indicator for the aeration in the aerobic basin 123, which is one step in sewage treatment processes.

The effluent water quality is an indicator which indicates water quality of effluent water going out from the sewage treatment system 1 and includes at least one of a total nitrogen concentration, or T-N, a total phosphorus concentration, or T-P, or a chemical oxygen demand, or COD. T-N represents a concentration of total nitrogen compounds included in the effluent water. T-P represents a concentration of total phosphoric acid compounds included in the effluent water. COD represents an oxygen quantity required to oxidize oxidizable substances in the effluent water. These kinds of effluent water quality are measured by the sensor 15 which is installed in the release port 131 from the secondary clarifier 13, which is also referred to as a sensor 15i.

### Support System

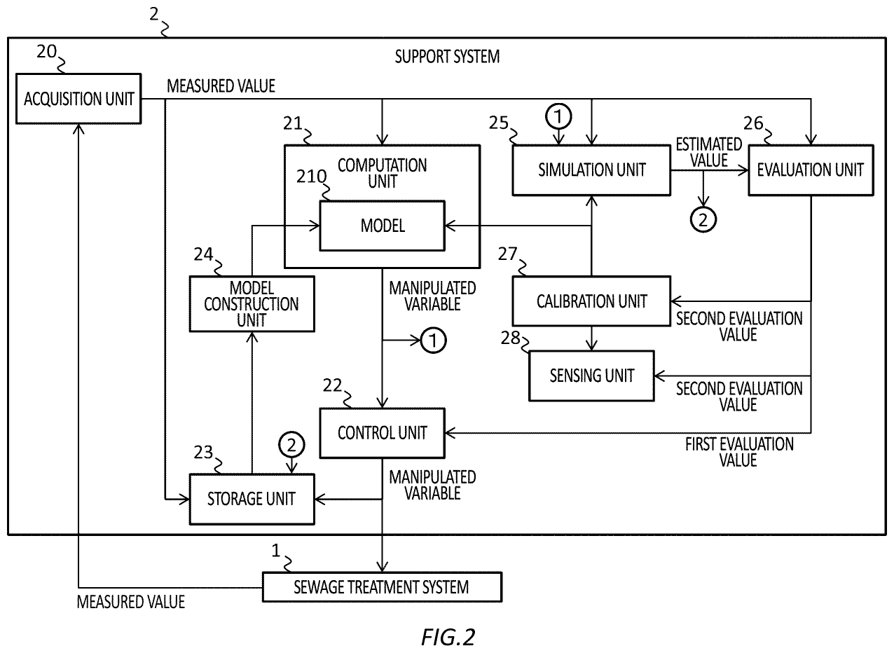

FIG. 2 illustrates a support system 2 according to the present embodiment together with the sewage treatment system 1. The support system 2 is for supporting an operation of the sewage treatment system 1 and includes an acquisition unit 20, a computation unit 21, a control unit 22, a storage unit 23, a model construction unit 24, a simulation unit 25, an evaluation unit 26, a calibration unit 27, and a sensing unit 28. The support system 2 may be installed in a central control room in a sewage treatment plant or may be realized by a cloud server on the Internet.

### ((Acquisition Unit 20))

The acquisition unit 20 acquires a measured value in the sewage treatment system 1. The acquisition unit 20 may acquire the measured value from each sensor 15 in the sewage treatment system 1. The acquisition unit 20 may supply the acquired measured value to the computation unit 21, the storage unit 23, the simulation unit 25, and the evaluation unit 26.

### ((Computation Unit 21))

The computation unit 21 calculates a manipulated variable to be given to the sewage treatment system 1 depending on the measured value newly acquired. The computation unit 21 may use a model 210 for controlling the sewage treatment system 1 to calculate a manipulated variable. The manipulated variable may be a variable provided to a controlled subject and is also referred to as a control output variable. In the present embodiment, as an example, the manipulated variable may be a value which represents at least one of the pumping quantity, the airflow rate, the number of blowers, or DO.

Here, the model 210 according to the present embodiment may be a mathematical model which represents the sewage treatment process. The model 210 may use the influent water quality, namely the turbidity, and the manipulated variable such as the pumping quantity, the airflow rate, and the number of blowers as input variables and may use the management indicator such as NH₄—N and MLSS, and the effluent water quality such as T-N as output variables. The model 210 may include coefficients of a characteristic equation, namely a set of parameters, and information on a dead time for each variable. The dead time may be a temporal delay from a change in a value of the variable to a resulting impact showing up on the effluent water quality, and as an example, may be a time between when wastewater flows into the sewage treatment plant and when it goes out. The model 210 may be a model disclosed in Patent Document 1 described above, as an example, or may be generated by the model construction unit 24 described below. The model 210 may be stored in a storage area in the computation unit 21. It is noted that the model 210 may be stored in another location such as a location external to the support system 2, or may be stored in a cloud server, as an example.

Using the model 210 described above, the computation unit 21 may calculate the manipulated variable with an approach according to Patent Document 1 described above. The computation unit 21 may calculate the management indicator and the effluent water quality corresponding to the influent water quality and the manipulated variable as expected values, identify sets of computed values which include the calculated expected values among sets of computed values which include a combination of each value of the influent water quality, the manipulated variable, the management indicator, and the effluent water quality, and define a manipulated variable in any one of the sets of computed values as the manipulated variable to be given to the sewage treatment system 1.

### (((Calculation of Expected Value)))

The computation unit 21 may calculate the management indicator such as NH₄—N and MLSS and the effluent water quality such as T-N corresponding to the influent water quality and the manipulated variable as expected values. The computation unit 21 may input a measured value of the influent water quality and the manipulated variable given to the sewage treatment system 1 into the model 210, and calculate the corresponding effluent water quality and management indicator with the model 210, the process of which is also referred to as a model computation. The computation unit 21 may input a most recent measured value and manipulated variable into the model 210. The computation unit 21 may calculate the effluent water quality and the management indicator after a time has passed which corresponds to a dead time for each value of the influent water quality and the manipulated variable. A same applies when calculating the expected value of NH₄—N and MLSS. The computation unit 21 may calculate the expected value a few hours to several tens of hours after a time point at which the influent water quality supplied to the model 210 is measured.

### (((Calculation of the Manipulated Variable)))

The computation unit 21 may identify a set of computed values which includes the expected values calculated for the effluent water quality and the management indicator. For example, the computation unit 21 may perform a computation using, as an input to the model 210, a combination of input variables which includes each value of the influent water quality and the manipulated variable, such as an exhaustive combination as an example, and identify a set of computed values which includes the expected values calculated for the effluent water quality and the management indicator. The computation unit 21 may identify a set of computed values which meets a preset constraint condition.

The constraint condition may be, for example, a condition that the effluent water quality is a better value than a predetermined reference value. When an indicator for the effluent water quality is T-N, T-P, or COD, for any of them, the smaller the value, the better the value of the effluent water quality. The constraint condition may further include a condition for the management indicator. The condition for the management indicator may be, for example, a condition that NH₄—N is a better value, namely a smaller value, than a predetermined reference value. A reference value for the effluent water quality may be set arbitrarily.

The computation unit 21 may identify a set of computed values which makes a power cost minimal, namely a set of computed values as an optimum solution, among sets of computed values which meet the constraint condition. For example, the computation unit 21 estimates the respective power costs for a predetermined period, such as for 24 hours, assuming that control is performed based on respective sets of computed values, and identifies a set of computed values which makes the power cost minimal. The optimum solution may be derived, for example, according to an algorithm such as mixed-integer linear programming, or MILP.

Here, the power cost may vary depending on a combination of each value of the manipulated variable such as the pumping quantity, the airflow rate, the number of blowers, and the number of pumps. Even when a same airflow rate is applied, the power cost varies depending on a combination of the number of blowers and a blow period. In addition, an electricity charge varies depending on a time period. For example, the electricity charge during a night-time period tends to be less expensive compared to the electricity charge during a day-time period. Thus, even when a same pumping quantity is applied, the power cost varies depending on the time period of the treatment. Accordingly, when the pumping quantity is decreased during the day-time period and increased during the night-time period, it is possible to reduce the power cost while maintaining a total pumping quantity in a day.

In addition, each of a plurality of blowers 124 may be different in terms of a type, a rated voltage, or the like. In addition, even when they are of a same type, each blower 124 may have an individual difference and may also be different in terms of a degree of aging. Accordingly, even when they are controlled to output the same airflow rate, the power cost may vary depending on the blowers 124 to be operated. The computation unit 21 may identify a set of computed values which includes identification information of blowers 124 to be operated as the set of computed values which makes the power cost minimal. The computation unit 21 may identify a set of computed values by further using either of energy consumption and CO₂ emissions, in addition to the power cost.

The computation unit 21 may define the manipulated variable included in the identified set of computed values, such as the set of computed values as the optimum solution, as an example, as the manipulated variable to be given to the sewage treatment system 1. The computation unit 21 may correct the manipulated variable depending on the measured value or the estimated value of the management indicator such as NH₄—N.

For example, when the most recent measured value of NH₄—N exceeds an upper limit value of a reference range, the computation unit 21 may increase the manipulated variable for the airflow rate by a reference quantity α. In this way, the air or the oxygen quantity supplied to the aerobic basin 123 is increased to activate the microorganisms in the reaction vessel 12, thereby facilitating the degradation of NH₄—N. When the most recent measured value of NH₄—N is below a lower limit value of the reference range, the computation unit 21 may decrease the manipulated variable by a reference quantity β. In this way, driving power of the blowers 124 is reduced and the power cost in the sewage treatment system 1 is reduced. The reference range of NH₄—N and the reference quantities α, β of the manipulated variable may be set arbitrarily.

When the most recent estimated value of NH₄—N such as a value after 5 hours, as an example, exceeds the reference value and shows an increasing trend, the computation unit 21 may increase the manipulated variable for the airflow rate by a reference quantity γ. In this way, a supply of oxygen is increased to facilitate the degradation of NH₄—N. The reference value of NH₄—N and the reference quantity γ of the manipulated variable may be set arbitrarily.

The computation unit 21 may supply the calculated manipulated variable, such as the calculated and corrected manipulated variable, as an example, to the control unit 22 and the simulation unit 25. The computation unit 21 may calculate the manipulated variable according to a control cycle of the sewage treatment system 1 such as every 15 minutes and supply it to the control unit 22 and the simulation unit 25. The computation unit 21 may cause a display unit not shown to display the calculated manipulated variable.

### ((Control Unit 22))

The control unit 22 controls the sewage treatment system 1 depending on the manipulated variable calculated in the computation unit 21. For example, the control unit 22 may control an airflow rate of blowers 124 depending on the manipulated variable. The control unit 22 may perform control in a preset control cycle, such as every 15 minutes. The control unit 22 may supply a control signal which indicates the manipulated variable calculated by the computation unit 21 to the sewage treatment system 1 and the storage unit 23.

The control unit 22 may output the control signal to the sewage treatment system 1 when a first evaluation value calculated in the evaluation unit 26 described below meets a first reference condition. The first evaluation value may represent an evaluation of the sewage treatment process of the sewage treatment system 1, such as the airflow rate of the blowers 124. The control signal is output to the sewage treatment system 1 when such first evaluation value meets the first reference condition so that the control of the sewage treatment system 1 by the computation unit 21 and the control unit 22 continues when the sewage treatment process is good. When the control signal is not output from the control unit 22, the sewage treatment system 1 may be controlled by a control signal according to a user input to an input unit not shown.

The first reference condition may be a condition which is met by the first evaluation value when the sewage treatment process is good and may be a condition which is not met by the first evaluation value when the sewage treatment process is not good. As an example, the first reference condition may be that one first evaluation value calculated most recently falls within a reference range, or may be that an average value of a plurality of the first evaluation values calculated most recently falls within the reference range. The reference range may be a range which includes at least one of the upper limit value or the lower limit value.

### ((Storage Unit 23))

The storage unit 23 associates and stores the measured value measured in the sewage treatment system 1 at each time point and the manipulated variable given to the sewage treatment system 1. The storage unit 23 may associate and store the measured value supplied from the acquisition unit 20 and the manipulated variable supplied from the control unit 22. When the sewage treatment system 1 is controlled by a manual operation of a user, the storage unit 23 may associate and store the manipulated variable according to the manual operation and the measured value. The storage unit 23 may further store a result of a simulation by the simulation unit 25 described below.

### ((Model Construction Unit 24))

The model construction unit 24 generates the model 210. The model construction unit 24 may generate the model 210 based on the measured value in the sewage treatment system 1 and the manipulated variable given to the sewage treatment system 1. The model construction unit 24 may generate the model 210 by using a plurality of data sets which include a measured value measured in the sewage treatment system 1 at each time point and the manipulated variable applied to the sewage treatment system 1 in a state represented by the measured value.

Since the model 210 according to the present embodiment is constructed to include coefficients of the characteristic equation, namely a set of parameters, and information on the dead time of each variable, the model construction unit 24 may generate the model 210 by calculating the set of these parameters and the dead time. The model construction unit 24 may generate the model 210 by utilizing a modeling method according to Patent Document 2 described above.

The model construction unit 24 according to the present embodiment may calculate the set of parameters such that the management indicator and the effluent water quality calculated by using, as inputs, the measured value of the influent water quality and the actual value of the manipulated variable, are close to the measured values. The model construction unit 24 may calculate the set of parameters considering the dead times of respective variables, namely the influent water quality, or the turbidity, the pumping quantity, the airflow rate, the number of blowers, DO, NH₄—N, and MLSS as an example in the present embodiment.

The model construction unit 24 may calculate the dead time of each variable for the effluent water quality. For example, the model construction unit 24 may calculate the dead time with the approach according to Patent Document 1 described above. That is, the model construction unit 24 may determine, for each delay time, whether there is a correlation between a transition of values of variables over time when each of the values is delayed by the delay time and a transition of the measured value of the effluent water quality over time and may determine, for each variable, the delay time by which the correlation becomes strongest as the dead time of the variable.

The model construction unit 24 may calculate the set of parameters and the dead time to generate the model 210 and supply it to the computation unit 21.

### ((Simulation Unit 25))

The simulation unit 25 calculates, by simulation, a state of the sewage treatment system 1 depending on the manipulated variable calculated in the computation unit 21. The state of the sewage treatment system 1 depending on the calculated manipulated variable may be a state of the sewage treatment system 1 when the calculated manipulated variable is applied. The simulation unit 25 may perform a simulation every time the manipulated variable is supplied from the computation unit 21.

The simulation unit 25 may calculate an internal state of the reaction vessel 12. As an example, the simulation unit 25 may calculate a value which represents the internal state of the reaction vessel 12 at each position in a longitudinal direction, namely a flow direction of the sewage, and a depth direction in at least one of the anaerobic basin 121, the anoxic basin 122, or the aerobic basin 123 in the reaction vessel 12, the value of which is also referred to as an estimated value of the internal state. The estimated value of the internal state may represent, for example, at least one of NH₄—N, T-N, T-P, or COD. The internal state of the reaction vessel 12 may be a sewage treatment capability of the activated sludge in at least one of the anaerobic basin 121, the anoxic basin 122, or the aerobic basin 123. As an example, the simulation unit 25 may be able to simulate a behavior of a capability of nitrogen removal, namely nitrification and denitrification, a capability of phosphorus removal, and a capability of organic matter removal in the reaction vessel 12.

The simulation unit 25 may be able to simulate a behavior of an entire sewage treatment process. The simulation unit 25 may further calculate a state outside of the reaction vessel 12, such as the turbidity at each position in the primary clarifier 11 and a state of the treated water at each position in the secondary clarifier, such as at least one of T-N, T-P or COD. The simulation unit 25 may be able to calculate a transition of a state of the sewage and the treated water for each predetermined reference time, such as every 1 to 15 minutes, as an example.

The simulation unit 25 may calculate a state in a position at which the sensor 15 is not arranged. Additionally, or alternatively, the simulation unit 25 may calculate an estimated value obtained by estimating at least one kind of a measured value among a plurality of kinds of measured values measured by the sensor 15. The simulation unit 25 may supply the calculated result by the simulation to the evaluation unit 26. The simulation unit 25 may cause the display unit not shown to display the calculated result by the simulation.

The simulation unit 25 may include an activated sludge model, or ASM, which represents the sewage treatment process with a physicochemical formula. The activated sludge model describes mathematically, for each kind of reaction in the activated sludge, chemical kinetics, namely a reaction rate and its influence factor, and stoichiometry, namely a quantity of substance changed by a reaction, and is obtained by modeling the sewage treatment capability of the activated sludge in such a way as to approximate an actual capability. The activated sludge model may include parameters such as a specific growth rate and a half-saturation constant in at least one of the anaerobic basin 121, the anoxic basin 122, or the aerobic basin 123 in the reaction vessel 12. The specific growth rate may be a rate of increase of the microorganisms per unit time. The half-saturation constant may be a nutrient concentration when the reaction rate is half a maximum value, and in the anaerobic basin 121, it may be a concentration of inorganic phosphorus when the reaction rate of generating phosphoric acid from acetic acid and butyric acid is half the maximum value, and in the anoxic basin 122, it may be a concentration of inorganic nitrogen when the reaction rate of generating nitrogen from nitric acid and oxygen is half the maximum value, and in the aerobic basin 123, it may be a concentration of inorganic nitrogen when the reaction rate of generating nitrate nitrogen from ammonia nitrogen is half the maximum value. The activated sludge model may be “ASM No.2” or “No. 2d” suggested by the International Water Association, or IWA, as an example. The activated sludge model may be generated by using an ASM simulator which is commercially available.

### ((Evaluation Unit 26))

The evaluation unit 26 performs an evaluation depending on the result of the simulation. The evaluation unit 26 may be an example of a first evaluation unit and may calculate a first evaluation value depending on a result of a comparison between the value which represents the internal state of the reaction vessel 12 calculated by the simulation unit 25 and a predetermined reference value. The first evaluation value may be simply a difference between the estimated value of the internal state and the reference value or may be a value which is calculated by using the difference. The first evaluation value may represent the evaluation of the sewage treatment process in the sewage treatment system 1, such as the airflow rate of the blowers 124. The reference value of the first evaluation value may be set arbitrarily. The evaluation unit 26 may supply the first evaluation value to the control unit 22. The evaluation unit 26 may cause the display unit not shown to display the calculated first evaluation value.

The evaluation unit 26 may be an example of a second evaluation unit and may calculate a second evaluation value depending on an error between a measured value of at least one kind measured by the sensor 15 and an estimated value calculated by the simulation unit 25 of a kind which corresponds to that of the measured value. The evaluation unit 26 may calculate, for one preset kind of measured value, the second evaluation value depending on the error between the measured value and the estimated value. In this case, the second evaluation value may be simply an error between the measured value and the estimated value or may be a value which is calculated by using the error. The evaluation unit 26 may calculate each error between each of a plurality of preset kinds of measured values and the estimated value, and calculate a single second evaluation value depending on each of the plurality of errors calculated. In this case, the second evaluation value may be a value which is calculated by using the plurality of errors, such as an average of the plurality of errors, as an example. The second evaluation value may represent mainly an evaluation of accuracy of the simulation. The evaluation unit 26 may supply the second evaluation value to the calibration unit 27. The evaluation unit 26 may cause the display unit not shown to display the calculated second evaluation value.

### ((Calibration Unit 27))

The calibration unit 27 calibrates the simulation unit 25. Calibrating the simulation unit 25 may refer to adjusting parameters of the activated sludge model included in the simulation unit 25. The parameters to be adjusted may be, for example, the specific growth rate, the half-saturation constant, or the like. The calibration unit 27 may perform a calibration by recalculating the subject parameters.

The calibration unit 27 may execute the calibration when the second evaluation value calculated in the evaluation unit 26 meets a second reference condition. In this way, the calibration is executed when the accuracy of the simulation is poor.

The second reference condition may be a condition which is met by the second evaluation value when the accuracy of the simulation by the simulation unit 25 is not good and may be a condition which is not met by the second evaluation value when the accuracy of the simulation is good. As an example, the second reference condition may be that one second evaluation value calculated most recently falls within a reference range, or may be that an average value of a plurality of second evaluation values calculated most recently for one kind of the measured value falls within the reference range.

In addition to when the second evaluation value meets the second reference condition, the calibration unit 27 according to the present embodiment may calibrate the simulation unit 25 at reference intervals such as every week, as an example, or may calibrate the simulation unit 25 according to an instruction from the user.

In addition, the calibration unit 27 according to the present embodiment may further calibrate the model 210. Calibrating the model 210 may refer to recalculating at least one of the set of parameters or the dead time included in the model 210. The calibration unit 27 may calibrate the model 210 at reference intervals such as every week, as an example, or may calibrate the model 210 according to the instruction from the user. The calibration unit 27 may calibrate the model 210 with the approach according to Patent Document 1 described above.

### ((Sensing Unit 28))

The sensing unit 28 senses the sewage treatment system 1 as abnormal when the second evaluation value meets a third reference condition after the simulation unit 25 is calibrated. In this way, the sewage treatment system 1 may be sensed as abnormal, provided that the second evaluation value depending on the error between the measured value and the estimated value is not good although the accuracy of the simulation is supposed to be good. The sensing unit 28 may cause the display unit not shown to display that the sewage treatment system 1 is sensed as abnormal.

The third reference condition may be a condition which is met by the second evaluation value when the accuracy of the simulation by the simulation unit 25 is not good and may be a condition which is not met by the second evaluation value when the accuracy of the simulation is good. As an example, the third reference condition may be that one second evaluation value calculated most recently falls within a reference range, or may be that an average value of a plurality of the second evaluation values calculated most recently falls within the reference range. The third reference condition may be the same as or different from the second reference condition, and the reference range of the third reference condition may be a narrower or wider range compared to the reference range of the second reference condition.

According to the support system 2 described above, using the control model 210 generated based on the measured value in the sewage treatment system 1 and the manipulated variable given to the sewage treatment system 1, the manipulated variable to be given to the sewage treatment system 1 is calculated depending on the measured value newly acquired, and the state of the sewage treatment system 1 depending on the calculated manipulated variable is calculated by simulation. Accordingly, it is possible to operate the sewage treatment system 1 while checking the state of the sewage treatment system 1 so that reliability of the operation of the sewage treatment system 1 may be increased.

In addition, since the control model 210 and the simulation unit 25 are coordinated online, the state of the sewage treatment system 1 calculated by simulation may approximate the state of the actual sewage treatment system 1 by applying the manipulated variable to be given to the sewage treatment system 1 to the simulation successively. Accordingly, by referring to a result of the simulation, it is possible to operate the sewage treatment system 1 while maintaining the manipulated variable at an appropriate level, so that an operational cost and energy consumption of the sewage treatment system 1 may be reduced appropriately.

In addition, the internal state of the reaction vessel 12 is calculated by simulation, so that it is possible to operate the sewage treatment system 1 while checking the internal state of the reaction vessel 12. Accordingly, the reliability of the operation of the sewage treatment system 1 may be further increased.

In addition, the first evaluation value is calculated depending on the result of the comparison between the value which represents the internal state of the reaction vessel 12 calculated by the simulation and the predetermined reference value. Accordingly, the evaluation of the sewage treatment process, namely an evaluation of the manipulated variable given to the sewage treatment system 1 may be acquired.

In addition, the control signal is output to the sewage treatment system 1 when the first evaluation value meets the first reference condition. Accordingly, when the evaluation of the manipulated variable to be given to the sewage treatment system 1 is poor, control using the manipulated variable may be avoided.

In addition, the second evaluation value is calculated depending on the error between each of at least one kind of the measured value and the estimated value of a kind which corresponds to that of the measured value. Accordingly, an evaluation of the accuracy of the simulation may be acquired.

In addition, the simulation unit 25 is calibrated when the second evaluation value meets the second reference condition so that even when the accuracy of the simulation decreases due to a seasonal variation, a variation in the inflow quantity to the sewage treatment system 1, or the like, the calibration may be performed automatically to maintain good accuracy of the simulation.

In addition, the sewage treatment system 1 is sensed as abnormal when the second evaluation value meets the third reference condition after the calibration is executed. Accordingly, the sewage treatment system 1 may be sensed as abnormal when the evaluation of the accuracy of the simulation is poor although the accuracy of the simulation is supposed to be high due to the calibration.

### Operation of the Support System 2

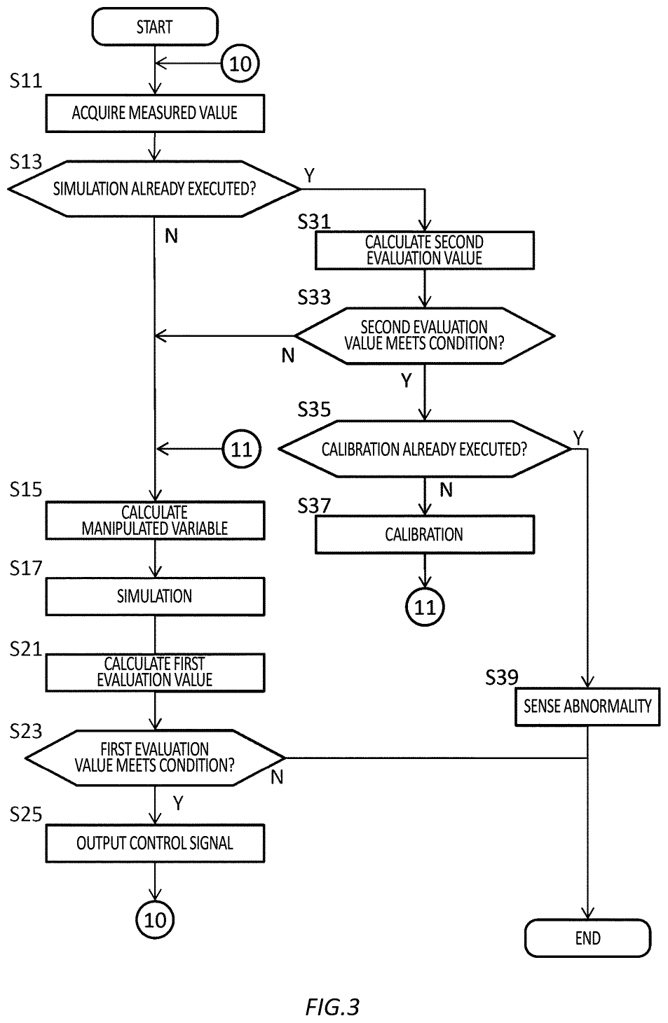

FIG. 3 illustrates the operation of the support system 2. The support system 2 supports the operation of the sewage treatment system 1 by performing processes of steps S11 to S39. The operation in the present figure will be described assuming that the second reference condition used by the calibration unit 27 to determine whether the calibration should be performed and the third reference condition used by the sensing unit 28 to determine whether an abnormality is sensed are a same condition.

In the step S11, the acquisition unit 20 acquires a measured value in the sewage treatment system 1. The acquisition unit 20 may acquire the measured value from each sensor 15 in the sewage treatment system 1.

In a step S13, the evaluation unit 26 determines whether the simulation by the simulation unit 25 is already executed. The evaluation unit 26 may determine whether a process in a step S17 described below is already executed, or may determine whether a process of the step S13 is being performed for a second time onward. When it is determined that the simulation is not executed yet, namely No in the step S13, the process may move on to a step S15. When it is determined that the simulation is already executed, namely Yes in the step S13, the process may move on to a step S31.

In the step S15, the computation unit 21 calculates the manipulated variable to be given to the sewage treatment system 1 depending on the measured value acquired in the step S11. The computation unit 21 may calculate the manipulated variable by using the model 210.

In the step S17, the simulation unit 25 calculates, by simulation, the state of the sewage treatment system 1 depending on the manipulated variable calculated in the step S15. The simulation unit 25 may calculate the internal state of the reaction vessel 12.

In a step S21, the evaluation unit 26 calculates the first evaluation value depending on the result of the comparison between the estimated value of the internal state of the reaction vessel 12 and the predetermined reference value.

In a step S23, the control unit 22 determines whether the first evaluation value meets the first reference condition. When it is determined that the first evaluation value meets the first reference condition, namely Yes in the step S23, the process may move on to a step S25. When it is determined that the first evaluation value does not meet the first reference condition, namely No in the step S23, the operation of the support system 2 may end. In this case, the sewage treatment system 1 may be controlled by the manual operation of the user.

In the step S25, the control unit 22 controls the sewage treatment system 1 depending on the manipulated variable calculated in the step S15. The control unit 22 may output the control signal which indicates the manipulated variable to the sewage treatment system 1.

When the step S25 ends, the process may move on to the step S11 described above. In this way, in a newly executed step S11, the measured value is acquired in the sewage treatment system 1 to which the manipulated variable calculated in the step S15 has applied, and in the step S13, it is determined that the simulation is already executed so that the process moves on to the step S31.

In the step S31, the evaluation unit 26 calculates the second evaluation value depending on the error between each of at least one kind of the measured value and the estimated value of a corresponding kind, namely the estimated value in the step S17.

In a step S33, the calibration unit 27 determines whether the second evaluation value meets the second reference condition. When it is determined that the second evaluation value does not meet the second reference condition, namely No in the step S33, the process may move on to the step S15 described above. When it is determined that the second evaluation value meets the second reference condition, namely Yes in the step S33, the process may move onto a step S35.

In the step S35, the calibration unit 27 determines whether the calibration is already executed. For example, the calibration unit 27 may determine whether the calibration is executed within a reference interval, such as within one week as an example, from a current time. When it is determined that the calibration is already executed, namely Yes in the step S35, the process may move on to a step S39. When it is determined that the calibration is not executed yet, namely No in the step S35, the process may move on to a step S37.

In the step S37, the calibration unit 27 calibrates the simulation unit 25. The calibration unit 27 may calibrate the model 210 in conjunction with the calibration of the simulation unit 25. When the step S37 ends, the process may move on to the step S15 described above.

In the step S39, the sensing unit 28 senses the sewage treatment system 1 as abnormal. When the process of the step S39 ends, the operation of the support system 2 may end.

If the third reference condition used by the sensing unit 28 to determine whether the abnormality is sensed and the second reference condition used by the calibration unit 27 to determine whether the calibration should be performed are different conditions, the sensing unit 28 may cause the process to move on to the step S15 described above when it is determined that the second evaluation value does not meet the third reference condition in the step S39, and may sense the sewage treatment system 1 as abnormal and end the operation of the support system 2 when it is determined that the second evaluation value meets the third reference condition.

### Variations

Though the support system 2 is described as including the control unit 22, the storage unit 23, the model construction unit 24, the calibration unit 27 and the sensing unit 28 in the embodiment described above, it may not include any of these. When the support system 2 does not include the control unit 22, the computation unit 21 may display the calculated manipulated variable and cause the user to operate the sewage treatment system 1. In addition, in this case, the support system 2 may be used as a training system for the sewage treatment system 1. When the support system 2 does not include the storage unit 23, the measured value in the sewage treatment system 1, the manipulated variable given to the sewage treatment system 1, or the like may be stored in a storage device external to the support system 2. When the support system 2 does not include the model construction unit 24, the computation unit 21 may use a model 210 generated in a device external to the support system 2 to calculate the manipulated variable. When the support system 2 does not include the calibration unit 27, the simulation unit 25 may not be calibrated. When the support system 2 does not include the sensing unit 28, the abnormality of the sewage treatment system 1 may not be sensed.

In addition, though the model 210 is described as a mathematical model which uses the influent water quality and the manipulated variable as the input variable and uses the management indicator and the effluent water quality as the output variable, it may be another model. For example, the model 210 may be a model which outputs the manipulated variable to be given to the sewage treatment system 1 when the measured value measured by the sensor 15 is supplied. Such model 210 may be a learning model generated by a learning process which uses learning data including the measured value measured by the sensor 15 and the manipulated variable given to the sewage treatment system 1. In this case, the model construction unit 24 may generate the model 210 by using an existing learning algorithm such as a neural network. The model construction unit 24 may generate the model 210 through reinforcement learning by using a reward value determined by a predetermined reward function. The reward function may be a function in which the reward value increases as the power cost, the energy consumption, or the carbon dioxide emissions decrease.

Various embodiments of the present invention may be described with reference to flowcharts and block diagrams whose blocks may represent (1) steps of processes in which operations are executed or (2) sections of devices responsible for executing operations. Particular stages and sections may be implemented by a dedicated circuit, a programmable circuit supplied together with computer-readable instructions stored on a computer-readable medium, and/or processors supplied together with computer-readable instructions stored on the computer-readable medium. The dedicated circuit may include digital and/or analog hardware circuits, and may include integrated circuits, or IC and/or discrete circuits. The programmable circuit may include a reconfigurable hardware circuit including logical AND, logical OR, logical XOR, logical NAND, logical NOR, and another logical operation, a memory element or the like such as a flip-flop, a register, a field programmable gate array, or FPGA and a programmable logic array, or PLA, or the like.

A computer-readable medium may include any tangible device that may store instructions to be executed by an appropriate device, and as a result, the computer-readable medium including instructions stored thereon includes a product including instructions that may be executed in order to create means for executing operations designated in the flowcharts or block diagrams. Examples of the computer-readable medium may include an electronic storage medium, a magnetic storage medium, an optical storage medium, an electromagnetic storage medium, a semiconductor storage medium, or the like. More specific examples of the computer-readable medium may include a floppy (registered trademark) disk, a diskette, a hard disk, a random access memory, or RAM, a read-only memory, or ROM, an erasable programmable read-only memory, or EPROM or flash memory, an electrically erasable programmable read-only memory, or EEPROM, a static random access memory, or SRAM, a compact disc read-only memory, or CD-ROM, a digital versatile disk, or DVD, a Blu-ray (registered trademark) disk, a memory stick, an integrated circuit card, or the like.

The computer-readable instruction may include an assembler instruction, an instruction-set-architecture, or ISA instruction, a machine instruction, a machine dependent instruction, a microcode, a firmware instruction, state-setting data, or either a source code or an object code described in any combination of one or more programming languages, including an object oriented programming language such as Smalltalk (registered trademark), JAVA (registered trademark), C++, or the like, and a conventional procedural programming language such as a “C” programming language or a similar programming language.

The computer-readable instruction may be provided for a processor or programmable circuit of a programmable data processing device, such as a computer, locally or via a local area network, or LAN, a wide area network, or WAN, such as the Internet, or the like to execute the computer-readable instruction in order to create means for executing the operations designated in the flowcharts or block diagrams. Here, the computer may be a personal computer, or PC, a tablet computer, a smartphone, a workstation, a server computer, a general purpose computer, a special purpose computer, or the like, or may be a computer system to which a plurality of computers are connected. Such computer system to which the plurality of computers are connected is also referred to as a distributed computing system, and is a computer in a broad sense. In a distributed computing system, a plurality of computers collectively execute a program by each of the plurality of computers executing a part of the program, and passing data during the execution of the program among the computers as needed.

Examples of the processor include a computer processor, a central processing unit, or CPU, a processing unit, a microprocessor, a digital signal processor, a controller, a microcontroller, and the like. The computer may include one processor or a plurality of processors. In a multi-processor system including a plurality of processors, the plurality of processors collectively execute a program by each processor executing a part of the program, and passing data during the execution of the program among the processors as needed. For example, in execution of multiple tasks, each of the plurality of processors may execute a portion of each task piece by piece by performing task-switching for each time slice. In this case, which portion of one program each processor is responsible for executing dynamically changes. Moreover, which portion of the program each of the plurality of processor is responsible for executing may be determined statically by multiprocessor-aware programming.

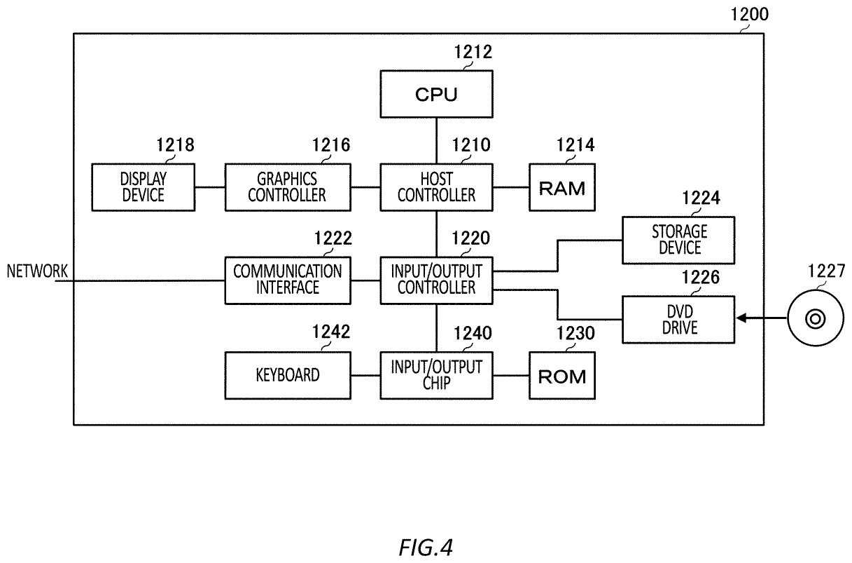

FIG. 4 illustrates an example of a computer 1200 in which a plurality of aspects of the present invention may be wholly or partially embodied. A program that is installed in the computer 1200 may cause the computer 1200 to function as operations associated with a device according to the embodiment of the present invention or one or more sections in the device, or may cause the computer 1200 to execute the operation or the one or more sections, and/or may cause the computer 1200 to execute processes according to the embodiment of the present invention or stages of the processes. Such a program may be executed by a CPU 1212 in order to cause the computer 1200 to execute particular operations associated with some or all of the blocks of flowcharts and block diagrams described herein.

The computer 1200 according to the present embodiment includes a CPU 1212, a RAM 1214, a graphics controller 1216, and a display device 1218, which are mutually connected by a host controller 1210. The computer 1200 also includes a communication interface 1222, a storage device 1224 such as a hard disk, input/output units such as a DVD-ROM drive 1226 and an IC card drive, which are connected to the host controller 1210 via an input/output controller 1220. The computer also includes legacy input/output units such as an ROM 1230 and a keyboard 1242, which are connected to the input/output controller 1220 via an input/output chip 1240.

The CPU 1212 operates according to programs stored in the ROM 1230 and the RAM 1214, thereby controlling each unit. The graphics controller 1216 acquires image data generated by the CPU 1212 on a frame buffer or the like provided in the RAM 1214 or in itself, and causes the image data to be displayed on a display device 1218.

The communication interface 1222 communicates with another electronic device via a network. The storage device 1224 stores a program and data used by the CPU 1212 in the computer 1200. The DVD-ROM drive 1226 reads a program or data from a DVD-ROM 1227 and provides the program or data to the storage device 1224 via the RAM 1214. The IC card drive reads the programs and the data from the IC card, and/or writes the programs and the data to the IC card.

The ROM 1230 stores therein a boot program or the like that is executed by the computer 1200 at the time of activation, and/or a program which depends on the hardware of the computer 1200. The input/output chip 1240 may also connect various input/output units to the input/output controller 1220 via a parallel port, a serial port, a keyboard port, a mouse port, or the like.

Programs are provided by a computer-readable medium such as the DVD-ROM 1227 or the IC card. The programs are read from the computer-readable medium, are installed in the storage device 1224, the RAM 1214, or the ROM 1230, which are also an example of the computer-readable medium, and are executed by the CPU 1212. Information processing described in these programs is read by the computer 1200, and provides cooperation between the programs and the various types of hardware resources described above. A device or method may be constructed by realizing the operation or processing of information according to the use of the computer 1200.

For example, when communication is executed between the computer 1200 and an external device, the CPU 1212 may execute a communication program loaded onto the RAM 1214 to instruct communication processing to the communication interface 1222, based on the processing described in the communication program. Under the control of the CPU 1212, the communication interface 1222 reads transmission data stored in a transmission buffer processing region provided in a recording medium such as the RAM 1214, the storage device 1224, the DVD-ROM 1227, or the IC card, transmits the read transmission data to the network, or writes reception data received from the network in a reception buffer processing region or the like provided on the recording medium.

In addition, the CPU 1212 may cause the RAM 1214 to read all or a necessary portion of a file or database stored in an external recording medium such as the storage device 1224, the DVD-ROM drive 1226, or the DVD-ROM 1227, the IC card, or the like, and may execute various types of processes on data on the RAM 1214. The CPU 1212 may then write back the processed data to the external recording medium.

Various types of information such as various types of programs, data, tables, and databases may be stored in a recording medium and subjected to information processing. The CPU 1212 may execute various types of processing on the data read from the RAM 1214, which includes various types of operations, information processing, conditional judging, conditional branch, unconditional branch, search/replace of information, or the like, as described throughout this disclosure and designated by an instruction sequence of programs, and writes the result back to the RAM 1214. In addition, the CPU 1212 may search for information in a file, a database, or the like in the recording medium. For example, when a plurality of entries each including an attribute value of a first attribute associated with an attribute value of a second attribute are stored in the recording medium, the CPU 1212 may search for, out of the plurality of entries, an entry with the attribute value of the first attribute designated that matches a condition, read the attribute value of the second attribute stored in the entry, and thereby acquire the attribute value of the second attribute associated with the first attribute meeting a predetermined condition.

The above-described program or software module may be stored in the computer-readable medium on the computer 1200 or near the computer 1200. In addition, a recording medium such as a hard disk or a RAM provided in a server system connected to a dedicated communication network or the Internet may be used as the computer-readable medium, thereby providing the program to the computer 1200 via the network.

While the present invention has been described by using the embodiments hereinabove, the technical scope of the present invention is not limited to the scope described in the above-described embodiments. It is apparent to persons skilled in the art that various changes or improvements may be made to the above-described embodiments. It is apparent from description of the claims that the embodiments to which such changes or improvements are made may also be included in the technical scope of the present invention.

It should be noted that each process such as the operations, procedures, steps, and stages in the device, system, program, and method shown in the claims, specification, and drawings may be executed in any order as long as the order is not particularly explicitly indicated by “prior to”, “before”, or the like and as long as the output from a previous process is not used in a later process. Even if the operational flow in the claims, specification, and drawings is described by using phrases such as “first”, “next”, or the like for the sake of convenience, it does not necessarily mean that it must be performed in this order.

### EXPLANATION OF REFERENCES

1: sewage treatment system;
2: support system;
10: inflow culvert;
11: primary clarifier;
12: reaction vessel;
13: secondary clarifier;
14: release unit;
20: acquisition unit;
21: computation unit;
22: control unit;
23: storage unit;
24: model construction unit;
25: simulation unit;
26: evaluation unit;
27: calibration unit;
28: sensing unit;
121: anaerobic basin;
122: anoxic basin;
123: aerobic basin;
124: blower;
125: tube;
131: release port;
132: tube;
133: tube;
210: model;
1200: computer;
1210: host controller;
1212: CPU;
1214: RAM;
1216: graphics controller;
1218: display device;
1220: input/output controller;
1222: communication interface;
1224: storage device;
1226: DVD-ROM drive;
1227: DVD-ROM;
1230: ROM;
1240: input/output chip;
1242: keyboard.

What is claimed is:

1. A support system comprising:
an acquisition unit which acquires a measured value in a sewage treatment system;
a computation unit which uses a model for controlling the sewage treatment system which is generated based on the measured value and a manipulated variable given to the sewage treatment system to calculate a manipulated variable to be given to the sewage treatment system depending on the measured value newly acquired; and
a simulation unit which calculates, by simulation, a state of the sewage treatment system depending on the manipulated variable calculated in the computation unit.

2. The support system according to claim 1, wherein
the sewage treatment system includes a reaction vessel for treating sewage; and
the simulation unit calculates an internal state of the reaction vessel.

3. The support system according to claim 2, further comprising a first evaluation unit which calculates a first evaluation value depending on a result of a comparison between a value which is calculated by the simulation unit and represents the internal state and a predetermined reference value.

4. The support system according to claim 3, further comprising:
a control unit which controls the sewage treatment system depending on the manipulated variable calculated in the computation unit, wherein
the control unit outputs a control signal to the sewage treatment system when the first evaluation value meets a first reference condition.

5. The support system according to claim 1, wherein
the measured value includes a plurality of measured values,
the simulation unit calculates an estimated value obtained by estimating the measured value of at least one kind among a plurality of kinds of the measured values, and
the support system further comprising:
a second evaluation unit which calculates a second evaluation value depending on an error between the measured value of the at least one kind and the estimated value of a kind which corresponds to that of the measured value.

6. The support system according to claim 5, further comprising:
a calibration unit which calibrates the simulation unit, wherein
the calibration unit executes a calibration when the second evaluation value meets a second reference condition.

7. The support system according to claim 6, further comprising a sensing unit which senses the sewage treatment system as abnormal when the second evaluation value meets a third reference condition after the simulation unit is calibrated.

8. A support method comprising:
acquiring a measured value in a sewage treatment system;
computing a manipulated variable to be given to the sewage treatment system by using a model for controlling the sewage treatment system which is generated based on the measured value and a manipulated variable given to the sewage treatment system to calculate the manipulated variable to be given to the sewage treatment system depending on the measured value newly acquired; and
simulating a state of the sewage treatment system by calculating, by simulation, the state of the sewage treatment system depending on the manipulated variable calculated in the computing.

9. A non-transitory computer readable medium having recorded thereon a support program which, when executed by a computer, causes the computer to function as:
an acquisition unit which acquires a measured value in a sewage treatment system;
a computation unit which uses a model for controlling the sewage treatment system which is generated based on the measured value and a manipulated variable given to the sewage treatment system to calculate a manipulated variable to be given to the sewage treatment system depending on the measured value newly acquired; and
a simulation unit which calculates, by simulation, a state of the sewage treatment system depending on the manipulated variable calculated in the computation unit.
